(19) United States
(12) Patent Application Publication
(10) Pub. No.: US 2022/0177364 A1
(43) Pub. Date: Jun. 9, 2022

(54) ADHESION PROMOTING LAYER, METHOD FOR DEPOSITING CONDUCTIVE LAYER ON INORGANIC OR ORGANIC-INORGANIC HYBRID SUBSTRATE, AND CONDUCTIVE STRUCTURE

(71) Applicant: Industrial Technology Research Institute, Hsinchu (TW)

(72) Inventors: Yiu-Hsiang Chang, Taoyuan City (TW); Wei-Yen Wang, Miaoli County (TW); Meng-Chi Huang, Taoyuan City (TW)

(73) Assignee: Industrial Technology Research Institute, Hsinchu (TW)

(21) Appl. No.: 17/199,462

(22) Filed: Mar. 12, 2021

(30) Foreign Application Priority Data
Dec. 9, 2020 (TW) 109143496

(51) Int. Cl. C03C 17/36; C23C 18/38; C23C 18/12

(52) U.S. Cl. CPC C03C 17/3607; C23C 18/38; C03C 17/3642; C03C 17/3649; C03C 2218/32; C03C 17/3697; C23C 18/1216; C23C 18/1287; C03C 2218/116; C03C 17/3668

(57) ABSTRACT

Provided are an adhesion promoting layer, a method for depositing a conductive layer on an inorganic or organic-inorganic hybrid substrate and a conductive structure. The adhesion promoting layer is suitable for depositing a conductive layer on an inorganic or organic-inorganic hybrid substrate, which includes a metal oxide layer and an interface layer. The metal oxide layer is disposed on the inorganic or organic-inorganic hybrid substrate. The interface layer is disposed between the metal oxide layer and the inorganic or organic-inorganic hybrid substrate. The metal oxide layer includes metal oxide and a chelating agent. The interface layer includes the metal oxide, the chelating agent and metal-nonmetal-oxide composite material.

### CROSS-REFERENCE TO RELATED APPLICATION

This application claims the priority benefit of Taiwan application serial no. 109143496, filed on Dec. 9, 2020. The entirety of the above-mentioned patent application is hereby incorporated by reference herein and made a part of this specification.

### BACKGROUND

### Technical Field

The present disclosure relates to an adhesion promoting layer and the application thereof, and in particular to an adhesion promoting layer, a method for depositing a conductive layer on an inorganic or organic-inorganic hybrid substrate, and a conductive structure.

### Description of Related Art

In various current technology products, it is usually necessary to deposit a metal layer on an inorganic substrate as a circuit pattern. In view of the problem of adhesion between the inorganic substrate and the metal layer, the metal layer is generally deposited by a dry deposition, such as physical vapor deposition (PVD) or chemical vapor deposition (CVD), on the inorganic substrate.

However, it is expensive to use the dry deposition to form the metal layer. In addition, for blind vias and through vias with high aspect ratios, there are often facing problems with low step coverage and overhang during the dry deposition, which increases process defects and reduces product reliability.

At present, the metal oxide layer is used as the adhesion promoting layer between the metal layer and the inorganic substrate. A metal oxide layer, such as a zinc oxide layer, is uniformly coated on the inorganic substrate, and the metal oxide layer is used to improve the adhesion between the inorganic substrate and the metal layer. However, the metal oxide layer is easily etched by an electroless plating solution with high alkalinity or high acidity, which causes damage to the metal oxide layer and reduces the adhesion between the inorganic substrate and the metal layer. Therefore, there is an urgent need for an adhesion promoting layer to join the metal layer and the inorganic substrate.

### SUMMARY

An embodiment of present disclosure provides an adhesion promoting layer, suitable for depositing a conductive layer on an inorganic or organic-inorganic hybrid substrate, including a metal oxide layer, disposed on the inorganic or organic-inorganic hybrid substrate; and an interface layer, disposed between the metal oxide layer and the inorganic or organic-inorganic hybrid substrate. The metal oxide layer includes metal oxide and a chelating agent, and the interface layer includes the metal oxide, the chelating agent and metal-nonmetal-oxide composite material.

Another embodiment of the present disclosure provides a method for depositing a conductive layer on an inorganic or organic-inorganic hybrid substrate, including: coating an adhesion promoting material on the inorganic or organic-inorganic hybrid substrate; performing a heat treatment to transform the crystalline phase of the adhesion promoting material to form an adhesion promoting layer, wherein the adhesion promoting layer includes a metal oxide layer and an interface layer, the interface layer is formed on the inorganic or organic-inorganic hybrid substrate, and the metal oxide layer is formed on the interface layer; and performing a wet deposition process to form a conductive layer on the adhesion promoting layer. The metal oxide layer includes a metal oxide and a chelating agent, and the interface layer includes the metal oxide, the chelating agent and metal-nonmetal-oxide composite material.

An alternative embodiment of the present disclosure provides a conductive structure, including an inorganic or organic-inorganic hybrid substrate; an adhesion promoting layer, disposed on the inorganic or organic-inorganic hybrid substrate; and a conductive layer, disposed on the adhesion promoting layer. The adhesion promoting layer includes a metal oxide layer, disposed on the inorganic or organic-inorganic hybrid substrate; and an interface layer, disposed between the metal oxide layer and the inorganic or organic-inorganic hybrid substrate. The metal oxide layer includes a metal oxide and a chelating agent, and the interface layer includes the metal oxide, the chelating agent and metal-nonmetal-oxide composite material.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic cross-sectional view of an adhesion promoting layer of an embodiment of the present disclosure.

FIG. 2 is a flowchart of a method for depositing a conductive layer on an inorganic substrate according to an embodiment of the present disclosure.

FIG. 3 is a high-resolution transmission electron microscope (HRTEM) analysis diagram of the adhesion promoting layer of Example 1.

FIG. 4 is a low grazing incidence X-ray diffraction (GIXRD) analysis diagram of the adhesion promoting layer of Example 1.

FIG. 5 is an HRTEM energy dispersive X-ray spectrum element distribution (HRTEM EDX mapping) analysis diagram of the adhesion promoting layer of Example 1.

FIG. 6 is a HRTEM EDX analysis diagram of the adhesion promoting layer of Example 1.

FIG. 7 is a field emission scanning electron microscopy (FESEM) image of the result of immersing the adhesion promoting layer of Example 1 in the electroless plating solution.

FIG. 8 shows the results of a tensile test (T-peel) for the structures of Example 2 and Comparative example.

### DESCRIPTION OF THE EMBODIMENTS

The embodiments are described in detail below with reference to the accompanying drawings, but the embodiments are not intended to limit the scope of the present disclosure. In addition, the drawings are for illustrative purposes only and are not drawn to the original dimensions. For the sake of easy understanding, the same elements in the following description will be denoted by the same reference numerals.

The terms mentioned in the text, such as “comprising”, “including” and “having” are all open-ended terms, i.e., meaning “including but not limited to”.

In addition, the directional terms mentioned in the text, such as “on” and “under”, are merely used to refer to the drawings and are not intended to limit the present disclosure.

When using terms such as “first” and “second” to describe a device, it is only used to distinguish these devices from each other, and does not limit the order or importance of these devices. Therefore, in some cases, the first device can also be called the second device, and the second device can also be called the first device, and it does not deviate from the scope of the present disclosure.

In addition, in the text, the range represented by “a value to another value” is a summary expression way to avoid listing all the values in the range one by one in the specification. Therefore, the record of a specific numerical range covers any numerical value within the numerical range, as well as a smaller numerical range defined by any numerical value within the numerical range.

The adhesion promoting layer of an embodiment of the present disclosure is suitable for depositing a conductive layer on an inorganic or organic-inorganic hybrid substrate. The adhesion promoting layer of the embodiment of the present disclosure is formed on an inorganic or organic-inorganic hybrid substrate by a wet process, so it has the characteristics of simple process with low cost. In addition, the adhesion promoting layer of the embodiment of the present disclosure has excellent acid and alkali resistance. Therefore, the adhesion promoting layer will not be etched and damaged by the electroless plating solution during the process of forming the conductive layer by the electroless plating process. The adhesion promoting layer of the embodiment of the present disclosure will be described in detail below.

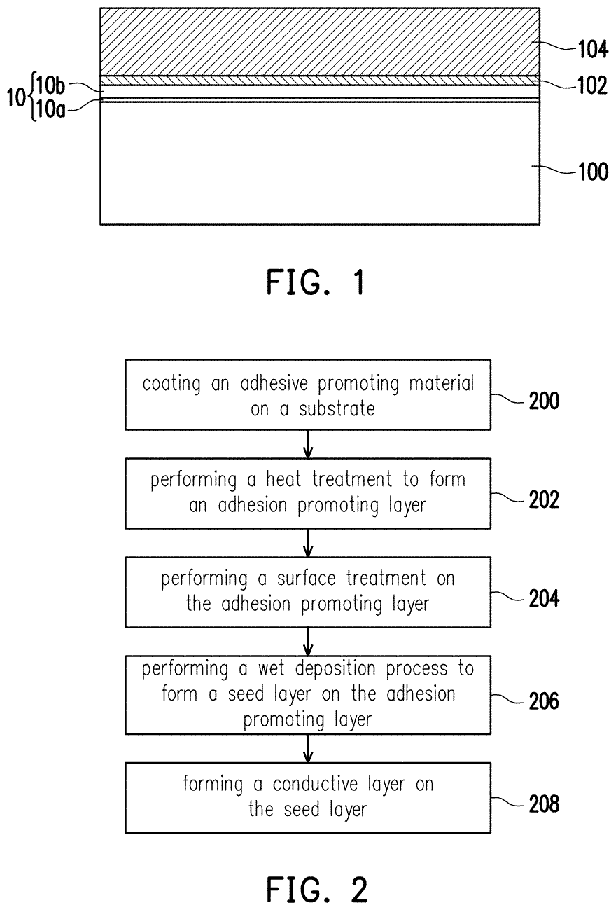

FIG. 1 is a schematic cross-sectional view of an adhesion promoting layer of an embodiment of the present disclosure. Referring to FIG. 1, the adhesion promoting layer 10 of the present embodiment is disposed on the substrate 100 for depositing the conductive layer 102 on the substrate 100. In the present embodiment, the substrate 100 may be an inorganic substrate or an organic-inorganic hybrid substrate. For example, the material of the inorganic substrate may be glass, ceramic, silicon, silicon oxide or a combination thereof, and the material of the organic-inorganic hybrid substrate may be carbon-silicon, polymer-silicon, carbon-ceramic, polymer-ceramic or a combination thereof. In addition, in the present embodiment, the conductive layer 102 may be used as a seed layer of the conductive layer 104 formed by a subsequent electroplating process, but the present disclosure is not limited thereto. The material of the conductive layer 102 is, for example, copper, but the present disclosure is not limited thereto. The conductive layer 104 may be a metal conductive layer or a nonmetal conductive layer, which is, for example, a gold layer, a silver layer, a copper layer, a nickel layer, a cobalt layer, a tin layer, a tungsten layer, a rhodium layer, a graphite layer, a graphene layer or a combination thereof, but the present disclosure is not limited thereto.

In the present embodiment, the adhesion promoting layer 10 includes an interface layer 10a and a metal oxide layer 10b. The metal oxide layer 10b is disposed on the substrate 100, and the interface layer 10a is disposed between the metal oxide layer 10b and the substrate 100. The total thickness of the adhesion promoting layer 10 is, for example, between 10.5 nm and 60 nm, wherein the thickness of the interface layer 10a is, for example, between 0.5 nm and 10 nm and the thickness of the metal oxide layer 10b is, for example, between 10 nm and 50 nm.

In the present embodiment, the metal oxide layer 10b includes metal oxide and a chelating agent. The metal oxide constitutes the main component of the metal oxide layer, which may be zinc oxide, titanium dioxide, aluminum oxide, nickel oxide, tin oxide, cobalt oxide, rhodium oxide, zirconium dioxide or a combination thereof. The metal oxide may improve the adhesion between the conductive layer 102 and the substrate 100. In addition, the chelating agent may be ethylenediamine (EN), 2,2′-bipyridine (Bipy), ethylenediaminetetraacetic acid (EDTA), nitrilotriacetic acid (NTA), diethylenetriaminepentaacetic acid (DTPA), citric acid (CA), tartaric acid (TA), gluconic acid (GA), a derivative thereof or a combinations thereof. In one embodiment, the chelating agent may be a nitrogen-containing chelating agent, such as ethylenediaminetetraacetic acid.

In the present embodiment, the interface layer 10a includes metal oxide, a chelating agent and metal-nonmetal-oxide composite material. In detail, in the process of forming the adhesion promoting layer 10, a layer of adhesion promoting material containing metal oxide and a chelating agent is coated on the substrate 100, and a part of the metal oxide and a part of the chelating agent are reacted with the material of the substrate 100 to form the interface layer 10a on the surface of the substrate 100, and the other part of the metal oxide and the other part of the chelating agent forms a metal oxide layer 10b. Therefore, the formed interface layer 10a includes the same metal oxide and chelating agent as in the metal oxide layer 10b, and contains the metal-nonmetal-oxide composite material formed by the reaction of the metal oxide, the chelating agent and the material of the substrate 100. In one embodiment, depending on the material of the substrate 100, the metal-nonmetal-oxide composite material is, for example, a metal-silicon-oxide composite material.

In the adhesion promoting layer 10, based on the analysis of the component weight ratio (for example, the field emission transmission electron microscopy (FETEM) electronic data system analysis), the ratio of the metal oxide is, for example, between 20% to 85% or 40% to 60%, based on the total weight of the adhesion promoting layer. If the ratio of the metal oxide is too high or too low, the poor adhesion may be occurred between the conductive layer 102 and the substrate 100. The ratio of the chelating agent is, for example, between 2% to 7% or 3% to 5%, based on the total weight of the adhesion promoting layer. If the ratio of the chelating agent is too high or too low, the poor adhesion may be occurred between the conductive layer 102 and the substrate 100. The ratio of the metal-nonmetal-oxide composite material is, for example, between 2% to 7% or 4% to 6%, based on the total weight of the adhesion promoting layer. If the content of the metal-nonmetal-oxide composite material is too high or too low, the poor adhesion may be occurred between the conductive layer 102 and the substrate 100.

Further, the adhesive layer 10 has a crystalline phase. In this embodiment, the adhesive promoting layer 10 has an anatase crystalline phase, and the formation temperature of the adhesive promoting layer 10 having an anatase crystalline phase is lower than the formation temperature of the adhesive layer having other crystalline phases, and the crystalline phase growth is easily controlled during the formation process.

The following describes the method for depositing a conductive layer on an inorganic or organic-inorganic hybrid substrate according to the embodiment of the present disclosure, in which the conductive layer may be deposited on the inorganic or organic-inorganic hybrid substrate by the adhesion promoting layer.

FIG. 2 is a flowchart of a method for depositing a conductive layer on an inorganic or organic-inorganic hybrid substrate according to an embodiment of the present disclosure. In the present embodiment, the adhesion promoting layer 10 in FIG. 1 will be taken as an example for description, and the same components as in FIG. 1 will not be described additionally.

Referring to FIG. 2, in step 200, an adhesion promoting material is coated on substrate 100. In the present embodiment, the thickness of the coated adhesion promoting material is, for example, between 10.5 nm and 60 nm. In the present embodiment, the adhesion promoting material is formed on the substrate 100 by a wet process. The wet process may be spin coating, immersion, spray coating, screen printing or blade coating, but the present disclosure is not limited thereto. In the present embodiment, the adhesion promoting material may be formed on the substrate 100 quickly and in a large area by the wet process. The adhesion promoting material is used to form the adhesion promoting layer 10, which includes a precursor of the metal oxide and a chelating agent. The precursor of the metal oxide is, for example, zinc oxide precursor, titanium dioxide precursor, aluminum oxide precursor, nickel oxide precursor, tin oxide precursor, cobalt oxide precursor, rhodium oxide precursor, zirconium dioxide precursor or a combination thereof. In some embodiments, the titanium dioxide precursor is, for example, titanium isopropoxide, titanium tetrachloride, titanium butoxide, titanium isobutoxide, titanium ethoxide, titanium diisopropoxide bis(acetylacetonate), butoxytitanium bis(ethyl acetoacetate), dibutoxytitanium bis(ethyl acetoacetate), titanium bis(triethanolamine)diisopropoxide or a combination thereof.

In the adhesion promoting material, the concentration of the precursor of the metal oxide is, for example, between 0.1 M and 1 M, and the solvent is, for example, water, alcohol or a combination thereof. In addition, in the adhesion promoting material, the concentration of the chelating agent is, for example, between 0.1 M and 1 M, and the solvent is, for example, water, alcohol or a combination thereof. The chelating agent may chelate the precursor of the metal oxide to provide the attachment ability between the metal oxides.

In step 202, a heat treatment is performed to transform the crystalline phase of the adhesion promoting material and strengthen the adhesion promoting material to form the adhesion promoting layer 10. In the present embodiment, the heat treatment may be rapid thermal annealing (RTA), furnace heating or microwave annealing. During the heat treatment process, the solvent in the metal oxide precursor and the chelating agent in the adhesion promoting material is volatilized, and a part of the metal oxide formed from the metal oxide precursor and a part of the chelating agent are reacted with the material of substrate 100 to form metal-nonmetal-oxide composite material. At this time, the metal-nonmetal-oxide composite material, the part of the metal oxide and the part of the chelating agent form the interface layer 10a on the surface of the substrate 100, and the other part of the metal oxide and the other part of the chelating agent form the metal oxide layer 10b. In this way, an adhesion promoting layer 10 made of the interface layer 10a and the metal oxide layer 10b is formed on the substrate 10. In addition, after the adhesion promoting layer 10 is formed, the adhesion promoting layer 10 may be annealed depending on the situation to reduce the stress in the adhesion promoting layer 10.

In step 204, a surface treatment may be performed on the adhesion promoting layer 10 depending on the situation. In the present embodiment, the surface treatment includes the following steps. First, the catalyst is adsorbed on the adhesion promoting layer 10 for surface modification. Next, the activator is used to perform an activation. The catalyst is, for example, a tin-palladium colloidal catalyst, an ionic palladium catalyst, a polymer palladium catalyst or a combination thereof.

In step 206, a wet deposition process is performed to form the conductive layer 102 on the adhesion promoting layer 10. The conductive layer 102 may be used as a seed layer for forming other conductive layers in subsequent processes. In the present embodiment, the wet deposition process is, for example, an electroless plating process (or called a chemical plating process). In the present embodiment, since the adhesion promoting layer 10 includes the metal oxide, the chelating agent and the metal-nonmetal-oxide composite material, the adhesion promoting layer 10 may have high acid and alkali resistance. Therefore, in the above wet deposition process, the adhesion promoting layer 10 may not be damaged by etching from a process solution with high acidity and alkalinity, thereby achieving high adhesion between the conductive layer and the inorganic or organic-inorganic hybrid substrate. In addition, in the present embodiment, the adhesion promoting layer 10 and the conductive layer 102 are formed by a wet process, so that the process difficulty and process cost may be reduced. In an embodiment of the present disclosure, the conductive layer includes a metal conductive layer and a nonmetal conductive layer, which includes gold (Au), silver (Ag), copper (Cu), nickel (Ni), cobalt (Co), tin (Sn), tungsten (W), rhodium (Ru), graphite, graphene, or a combination thereof, but the present disclosure is not limited thereto.

In step 208, the conductive layer 102 may be used as a seed layer for the electroplating process to form the conductive layer 104 on the conductive layer 102. Through step 200 to step 208, the conductive layer 104 may be deposited on the substrate 10.

The following Examples will be used to verify the adhesion promoting layer of the present disclosure.

### Example 1 (Formation of the Adhesion Promoting Layer)

First, the glass substrate is cleaned by a standard RCA cleaning to remove organic impurities and metal particles on the surface of the glass substrate, wherein a RCA cleaning solution includes ammonia, hydrogen peroxide and water (the ratio is 1:4:20), and a cleaning temperature is between 70° C. and 90° C. Then, the cleaned glass substrate is cleaned three times with water, and then dried with nitrogen. Then, the glass substrate is placed on a spin coating apparatus for adhesion promoting layer solution coating, wherein the adhesion promoting layer solution includes isopropanol, titanium diisopropoxide bis(acetylacetonate) (TTDB) (titanium dioxide precursor) and a chelating agent (EDTA included). The concentration of the titanium dioxide precursor is between 0.1 M and 1 M, the concentration of the chelating agent is between 0.1 M and 1 M, and the spin coating speed is controlled between 3000 rpm and 6000 rpm. After the spin coating is completed, the glass substrate on which the adhesion promoting layer is attached is sintered at a high temperature, wherein a sintering temperature is controlled between 400° C. and 600° C. After sintering, the adhesion promoting layer of Example 1 may be obtained.

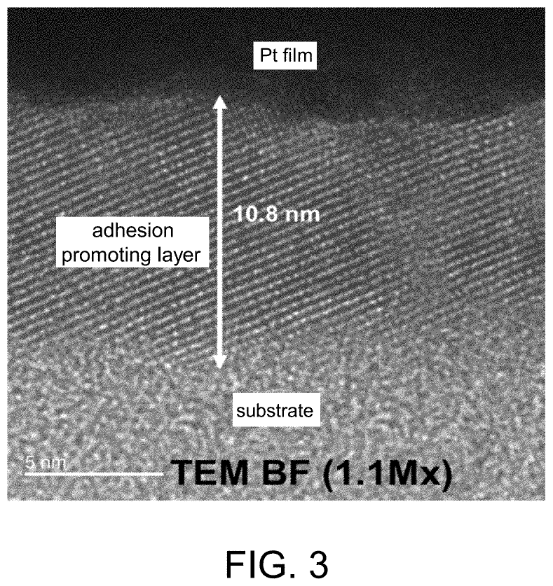

The adhesion promoting layer of Example 1 is analyzed by a high resolution transmission electron microscope (HRTEM), and it can be seen that the adhesion promoting layer of Example 1 has a crystalline phase, as shown in FIG. 3.

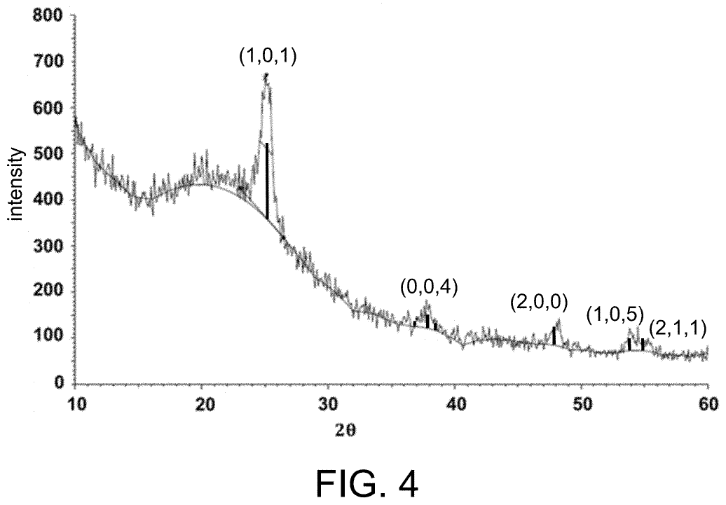

The adhesion promoting layer of Example 1 is analyzed by a low grazing incidence X-ray Diffraction (GIXRD), and it can be seen that the adhesion promoting layer of Example 1 has a crystalline phase, as shown in FIG. 4. The crystalline structure of the adhesion promoting layer of Example 1 is (1, 0, 1), (0, 0, 4), (2, 0, 0), (1, 0, 5) and (2, 1, 1), which is an anatase crystalline phase.

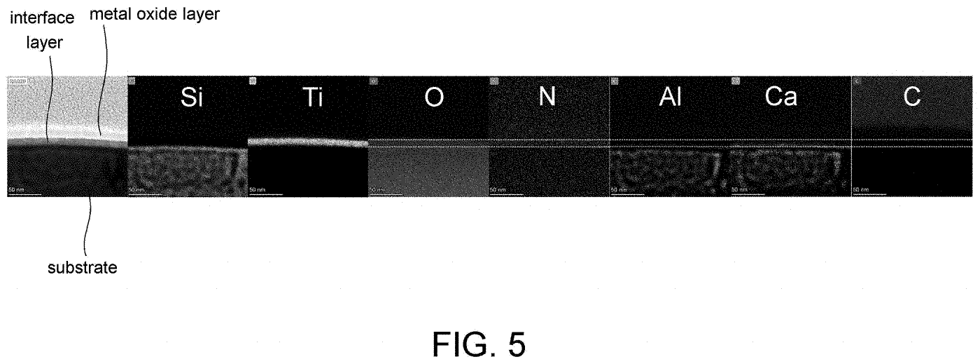

The adhesion promoting layer of Example 1 is analyzed by an HRTEM EDX mapping, and it can be seen that elements such as Si, Ti, O, N, Al, Ca, and C are analyzed, as shown in FIG. 5. Therefore, it can be known that the adhesion promoting layer of Example 1 includes metal oxide layer (titanium dioxide), nitrogen-containing chelating agent (EDTA included) and an interface layer (metal-nonmetal-oxide composite material).

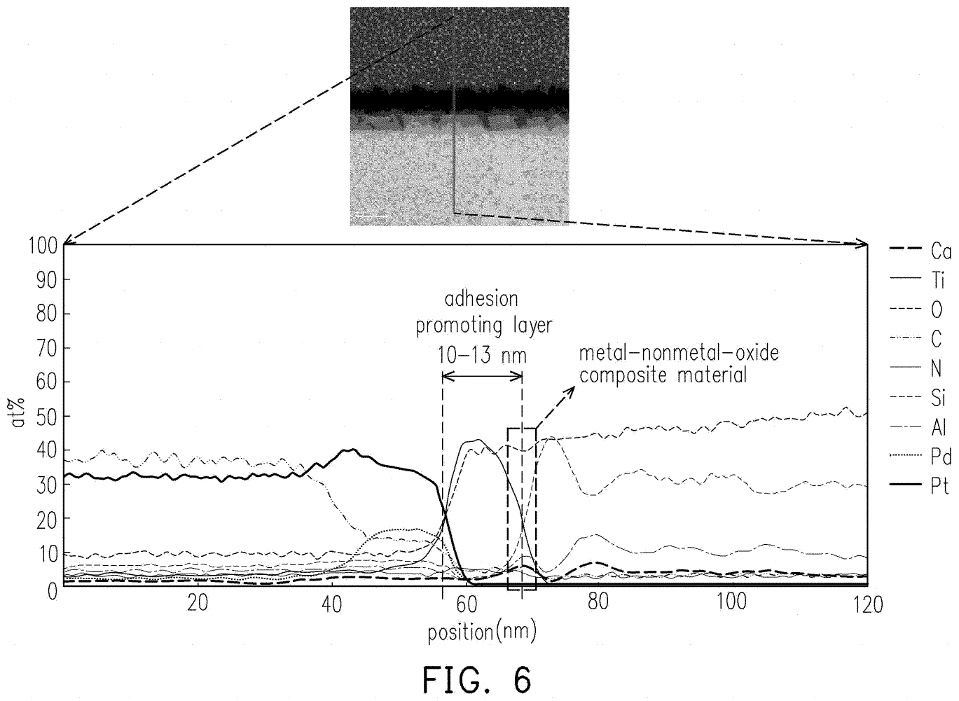

The adhesion promoting layer of Example 1 is analyzed by a HRTEM EDX, and it can be seen that the adhesion promoting layer of Example 1 includes a metal oxide layer and an interface layer, as shown in FIG. 6.

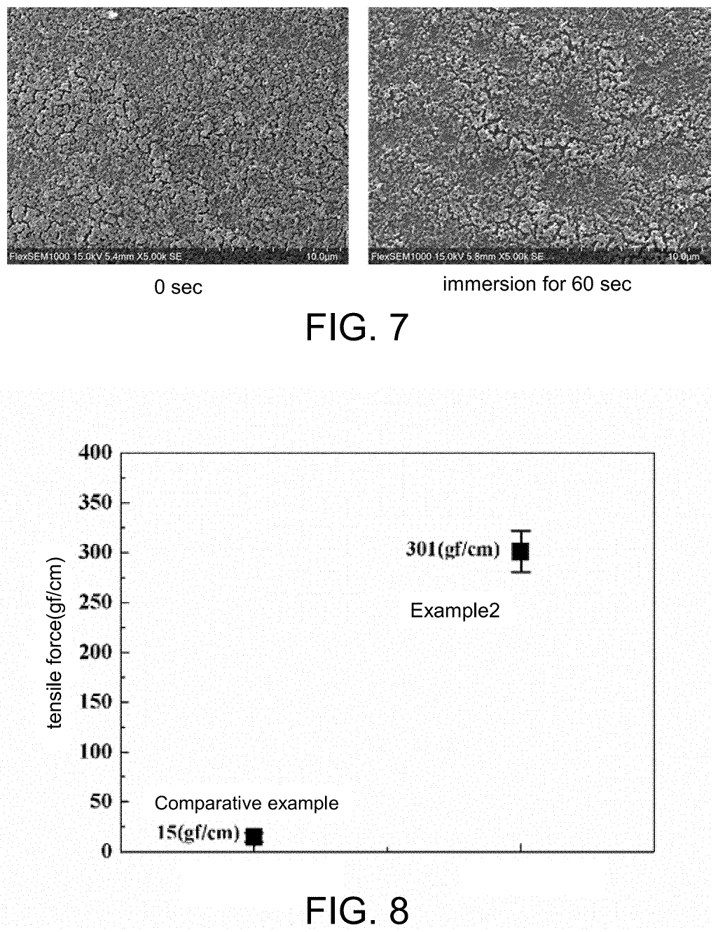

The adhesion promoting layer of Example 1 is immersed in the electroless plating solution for 0 and 60 seconds, respectively. The results are shown in FIG. 7. It can be seen that the adhesion promoting layer of Example 1 has no obvious defects or abnormalities after being immersed for 60 seconds. Therefore, it can be known that the adhesion promoting layer of Example 1 has high acid and alkali resistance.

Hereinafter, the effect of the adhesion promoting layer of the present disclosure will be described with Example 2 and Comparative example.

### Example 2

The glass substrate with the adhesion promoting layer in Example 1 is immersed in a tin-palladium colloidal catalyst solution for surface modification for 5 to 8 minutes. Then, the glass substrate is immersed in the activator for an activation for 1 to 3 minutes. Then, the glass substrate is placed in a commercial electroless copper plating solution for metallization to obtain a preliminary sample of Example 2, wherein the reaction temperature of electroless copper plating is controlled between 35° C. and 38° C., and the metallization time is between 5 to 8 minutes. Then, the sample is subjected to a rapid thermal annealing treatment, wherein the temperature is controlled between 400° C. and 600° C., and the time is between 5 to 10 minutes. Then, the sample is subjected to copper electroplating, and the thickness of the formed copper layer is controlled at 10 to 15 μm. After that, the sample is subjected to a rapid thermal annealing treatment to obtain the final sample of Example 2, wherein the temperature is controlled between 400° C. and 600° C., and the time is between 5 to 10 minutes.

### Comparative Example (without a Chelating Agent)

The preparation method of the Comparative example is the same as that of the Example 2, except that the adhesion promoting layer of the Comparative example does not include a chelating agent.

A tensile test (T-peel) was performed on the structures of Example 2 and Comparative example, and the results are shown in FIG. 8. It can be seen in FIG. 8 that the adhesion promoting layer including a chelating agent may lead to a higher adhesion between the conductive layer and the glass substrate.

It will be apparent to those skilled in the art that various modifications and variations may be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. An adhesion promoting layer, suitable for depositing a conductive layer on an inorganic or organic-inorganic hybrid substrate, comprising:
a metal oxide layer, disposed on the inorganic or organic-inorganic hybrid substrate; and
an interface layer, disposed between the metal oxide layer and the inorganic or organic-inorganic hybridsubstrate,
wherein the metal oxide layer comprises metal oxide and a chelating agent, and the interface layer comprises the metal oxide, the chelating agent and metal-nonmetal-oxide composite material.

2. The adhesion promoting layer of claim 1, wherein the metal oxide comprises zinc oxide, titanium dioxide, aluminum oxide, nickel oxide, tin oxide, cobalt oxide, rhodium oxide, zirconium dioxide or a combination thereof.

3. The adhesion promoting layer of claim 1, wherein the chelating agent comprises ethylenediamine, 2,2′-bipyridine, ethylenediaminetetraacetic acid, aminotriacetic acid, diethylenetriaminepentaacetic acid, citric acid, tartaric acid, gluconic acid, a derivative thereof or a combination thereof.

4. The adhesion promoting layer of claim 1, wherein the metal-nonmetal-oxide composite material is formed by a reaction of the metal oxide, the chelating agent and the inorganic or organic-inorganic hybrid substrate.

5. The adhesion promoting layer of claim 1, wherein the adhesion promoting layer has a crystalline phase.

6. The adhesion promoting layer of claim 5, wherein the crystalline phase is an anatase crystalline phase.

7. The adhesion promoting layer of claim 1, wherein the ratio of the metal oxide is between 40% and 85% based on the total weight of the adhesion promoting layer.

8. The adhesion promoting layer of claim 1, wherein the ratio of the chelating agent is between 2% and 7% based on the total weight of the adhesion promoting layer.

9. The adhesion promoting layer of claim 1, wherein the ratio of the metal-nonmetal-oxide composite material is between 2% and 7% based on the total weight of the adhesion promoting layer.

10. The adhesion promoting layer of claim 1, wherein the material of the inorganic or organic-inorganic hybrid substrate comprises glass, ceramic, silicon, silicon oxide, carbon-silicon, polymer-silicon, carbon-ceramic, polymer-ceramic or a combination thereof.

11. The adhesion promoting layer of claim 1, wherein the material of the conductive layer comprises gold, silver, copper, nickel, cobalt, tin, tungsten, rhodium, graphite, graphene or a combination thereof.

12. A method for depositing a conductive layer on an inorganic or organic-inorganic hybrid substrate, comprising:
coating an adhesion promoting material on the inorganic or organic-inorganic hybrid substrate;
performing a heat treatment to transform the crystalline phase of the adhesion promoting material to form an adhesion promoting layer, wherein the adhesion promoting layer comprises a metal oxide layer and an interface layer, the interface layer is formed on the inorganic or organic-inorganic hybrid substrate, and the metal oxide layer is formed on the interface layer; and
performing a wet deposition process to form a conductive layer on the adhesion promoting layer,
wherein the metal oxide layer comprises a metal oxide and a chelating agent, and the interface layer comprises the metal oxide, the chelating agent and metal-nonmetal-oxide composite material.

13. The method of claim 12, wherein a method of coating the adhesive promoting material on the inorganic or organic-inorganic hybrid substrate comprises spin coating, dipping, spraying, screen printing or blade coating.

14. The method of claim 12, wherein the wet deposition process comprises an electroless plating process.

15. The method of claim 12, wherein the heat treatment comprises a rapid thermal annealing, a furnace heating or a microwave annealing.

16. The method of claim 12, wherein after forming the adhesion promoting layer and before performing the wet deposition process, further comprises performing a surface treatment on the adhesion promoting layer, and the surface treatment comprises:
adsorbing a catalyst on the adhesion promoting layer for a surface modification; and
activating the catalyst.

17. The method of claim 12, wherein the metal oxide comprises zinc oxide, titanium dioxide, aluminum oxide, nickel oxide, tin oxide, cobalt oxide, rhodium oxide, zirconium dioxide or a combination thereof.

18. The method of claim 12, wherein the chelating agent comprises ethylenediamine, 2,2′-bipyridine, ethylenediaminetetraacetic acid, aminotriacetic acid, diethylenetriaminepentaacetic acid, citric acid, tartaric acid, gluconic acid, a derivative thereof or a combination thereof.

19. The method of claim 12, wherein the metal-nonmetal-oxide composite material is formed by a reaction of the metal oxide, the chelating agent and the material of the inorganic or organic-inorganic hybrid substrate.

20. The method of claim 12, wherein the adhesion promoting layer has an anatase crystalline phase.

21. A conductive structure, comprising:
an inorganic or organic-inorganic hybrid substrate;
an adhesion promoting layer, disposed on the inorganic or organic-inorganic hybrid substrate; and
a conductive layer, disposed on the adhesion promoting layer,
wherein the adhesion promoting layer comprises:
a metal oxide layer, disposed on the inorganic or organic-inorganic hybrid substrate; and
an interface layer, disposed between the metal oxide layer and the inorganic or organic-inorganic hybrid substrate,
wherein the metal oxide layer comprises a metal oxide and a chelating agent, and the interface layer comprises the metal oxide, the chelating agent and metal-nonmetal-oxide composite material.
